(19) United States
(12) Patent Application Publication
(10) Pub. No.: US 2004/0099068 A1
(43) Pub. Date: May 27, 2004

(54) Sampling cylinder apparatus

(76) Inventor: Brian H. Welker, Sugar Land, TX (US)

Correspondence Address: BLACKWELL SANDERS PEPER MARTIN LLP, 720 OLIVE STREET, SUITE 2400, ST. LOUIS, MO, 63101, US

(21) Appl. No.: 10/301,902

(22) Filed: Nov. 22, 2002

(51) Int. Cl. G01N 1/20; G01N 1/22

(52) U.S. Cl. 73/863.71; 73/863.52

(57) ABSTRACT

Apparatus is provided for sampling of natural gas. The apparatus includes a fixed volume cylinder with a side wall and opposite end walls. A valve assembly is mounted in at least one end wall with the end wall functioning as a valve body housing.

### BACKGROUND OF THE INVENTION

In the natural gas industry, samples of the natural gas product are frequently taken for testing such things as the constituents and Btu value of the natural gas. Natural gas, even though often referred to as gas, may contain both liquid and gas hydrocarbon components. One common means of collecting a sample for remote testing is the use of a sampling cylinder. There are two basic types of sampling cylinder, a constant pressure cylinder (variable volume) and a fixed volume standard cylinder. They differ in that the constant pressure cylinder uses a moveable piston to maintain the collected hydrocarbons at a predetermined pressure. The standard cylinder has a fixed volume chamber providing simplicity and reduced cost relative to the constant pressure cylinder. The constant pressure cylinder is utilized generally when a constant pressure is needed, i.e. to maintain the hydrocarbons in desired phases, i.e. liquid and/or gas. While sampling cylinders known in the art are effective in operation, they do pose problems. In the case of constant pressure cylinders, they are expensive and complicated. With regard to standard cylinders, which are the type of the present invention, they are prone to the possibility of leaks at numerous fittings. Standard cylinders also require labor for hand assembly, and because of their structure, they can be damaged during the assembly process.

A prior art sampling cylinder of the standard cylinder type is a model 316L-HDF4-500 from Whitey of Highland Heights, Ohio. It utilizes a cylinder, having a side wall with integral end walls. Integral nipples are provided on opposite ends into which complete valve assemblies are screwed and sealed in place by various sealing elements, for example O-rings. A rupture disc may also be provided to protect the cylinder from overpressurization. A gauge is usually attached in-line with one of the valve assemblies which is in turn attached at one end of the cylinder. The standard sampling cylinder apparatus, although generally effective, has numerous joints which provide the possibility of leaks and require assembly steps. It also utilizes relatively expensive valves which are separate from the cylinder and attached thereto at the attachment nipples. Typically, such valves are made of stainless steel. Such a valve is a model NV-1 from Welker Engineering of Sugar Land, Tex.

A sampling cylinder apparatus includes the cylinder, a pair of shut-off valves and optionally a rupture disc and gauge. The use of two valves allows for the cylinder to be purged, with one valve being an outlet and the other valve providing an inlet. Both valves are selectively openable and closable to permit and prevent flow of fluid from a source of hydrocarbon into and out of the sampling apparatus.

The cylinders used in the sampling apparatus are preferably made by a spin forming technology. This involves the formation of a cylinder with an integral nipple at each end. The formation process provides a relatively uniform wall thickness both in the side wall of the cylinder and at the rounded ends up through the end of the nipple. The nipple is then internally threaded to accept the threaded end of a valve housing or the like. Formation of such a cylinder can be done with a material such as aluminum alloy, using a relatively cool process, or by heating the steel to a temperature allowing its formation into the cylindrical side wall and end wall shapes. The walls of such cylinders are typically relatively uniform in thickness which helps in the use of an efficient formation process. The wall thickness, being generally thin and uniform, necessitated the use of integral end nipples for the attachment of complete valves. Also, it necessitates forming ends with a bore through the nipple to facilitate the manufacture of the cylinder with integral nipple.

The provision of nipples on the ends of a cylinder necessitates the use of separate and complete valves. A separate valve, as seen in FIG. 1 includes a housing with a coupler, a body mounted in the housing, a valve element mounted in the body and a valve seat. Other attachments such as a rupture disc and gauge are attached to the cylinder via the nipple and various couplings. Because of the thinness of the wall of such formed cylinders, there were no known design options for attaching valve components and other devices as complete units to the cylinder other than through in-line attachment of the various components. Such structure provided many joints resulting in potential leak sources.

There is thus a need for a sampling cylinder apparatus that allows the integration of the various components and the provision of a monolithic sample cylinder apparatus which will permit the reduction of leak points and unnecessary components, such as the valve housing, for the attached devices as for example, couplers, valves, rupture discs and gauges.

The present invention provides such an integrated structure and utilizes a portion of the cylinder to replace a valve housing allowing the valve body to be directly attached to the cylinder.

### SUMMARY OF INVENTION

The present invention provides for a sampling cylinder apparatus usable to collect a sample of hydrocarbon fluid from a source of such fluid. Such an apparatus utilizes a fixed volume cylinder having a side wall and a pair of end walls defining an interior storage chamber. A filling port and a valve port are each formed in at least one of the end walls. A passageway is formed within a wall of the cylinder forming a flow passage in flow communication between the interior storage chamber, the valve port and the filling port. A valve assembly is provided and is associated with the end wall containing the valve port. The valve assembly includes a valve element removably mounted within the valve port and is operable to selectively permit flow and prevent flow of fluid into and out of the storage chamber through the filling port.

### BRIEF DESCRIPTION OF DRAWINGS

FIG. 1 is a sectional view illustrating a prior art sampling cylinder apparatus.

FIG. 2 is a sectional view of a sampling cylinder apparatus of the present invention showing the right hand valve assembly in an open position and a left hand valve assembly in a closed position.

FIG. 3 is a sectional view of an alternate embodiment of the present invention showing the right hand valve assembly in an open position and the left hand valve assembly in a closed position.

FIG. 4 is an end section view taken along the line 4-4, FIG. 2, and also illustrates a pressure gauge attached to the cylinder.

FIG. 5 is a section view taken along the line 5-5, FIG. 3, showing the alternate embodiment with a pressure gauge attached to the cylinder.

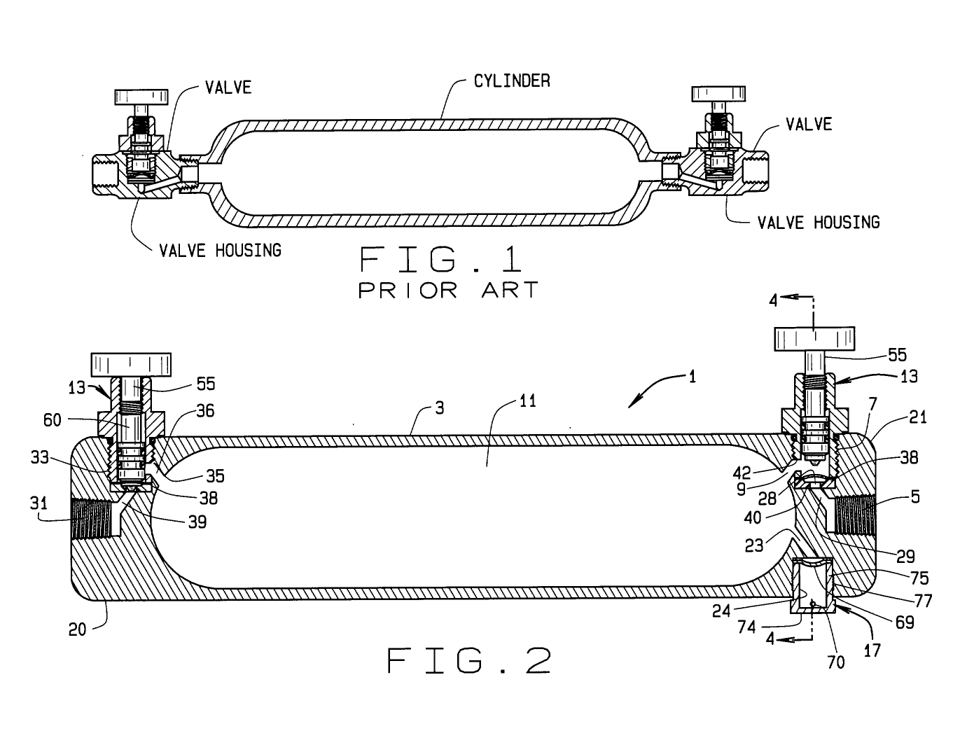

### DETAILED DESCRIPTION

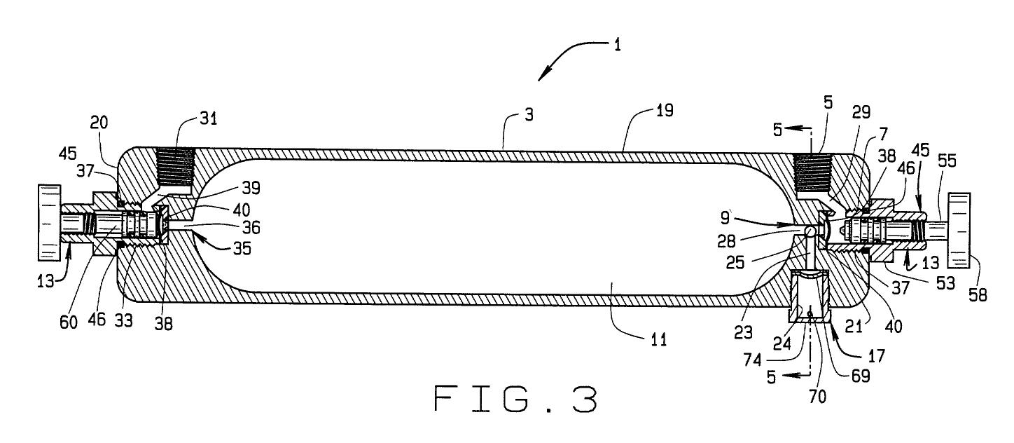

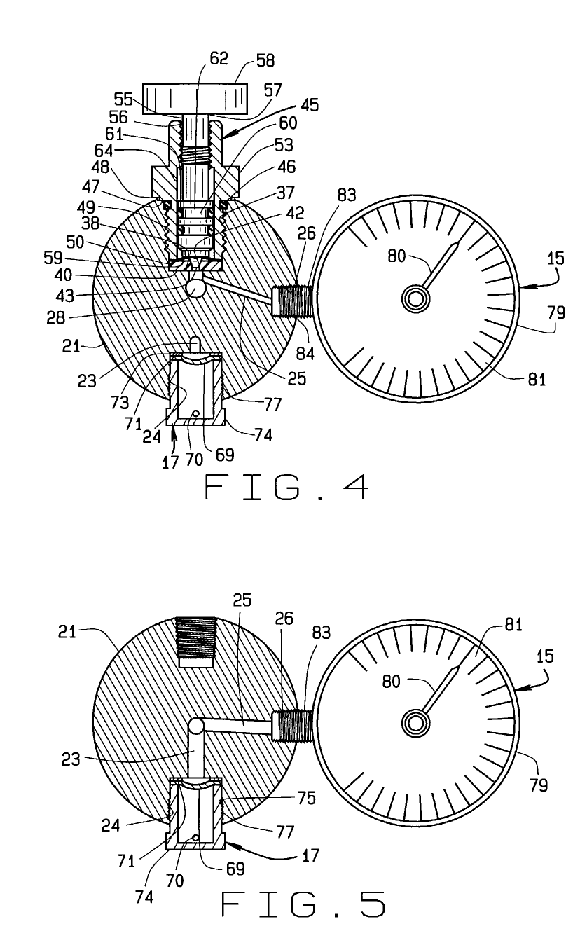

The reference numeral 1 designates generally, a natural gas sampling apparatus shown in FIGS. 2 and 3 utilizing a cylinder 3 having an inlet port 5 and a valve port 7 with a flow passage designated generally 9 forming a flow path communicating between a constant or fixed volume interior chamber 11 and the inlet port 5. A valve assembly generally designated 13 is mounted to the cylinder 3 with a portion of the cylinder serving as the valve housing. The valve assembly 13 is operable for selectively permitting and preventing the flow of fluid between the inlet port 5 and the interior chamber 11 through the flow passage 9. The apparatus 1 may also be provided with pressure indicating device 15 shown in FIGS. 4 and 5 and a pressure relief device 17.

As shown, the cylinder 3 is a monolithic structure comprising a side wall 19 and a pair of opposite end walls 20, 21. The cylinder 3 is preferably an integral structure where the end walls are integral with the side wall 19 and seamless. Preferably, the cylinder 3 is formed by spin forming as is known in the art or may be forged, cast, machined or molded. Preferably it is of a metal alloy such as aluminum alloy. The cylinder 3 may also be of a polymeric or composite material. A supplier of such cylinders is Hydrospin of Huntington Beach, California.

At least one of the end walls, and as illustrated, end wall 21, has the inlet port 5, the valve port 7 and the flow passage 9 formed therein. Also, as best seen in FIGS. 3, 4, 5, the flow passage 9 can be branched having a branch 23 in flow communication with a port 24 and a branch 25 communicating with a port 26 (FIGS. 4, 5). The flow passage 9 also includes branch 28 and connects to the chamber 11, branches 23 and 25 and opens into the valve port 7. A branch 29 of the passage 9 connects the inlet port 5 in flow communication with the valve port 7 at a position later described (FIGS. 2, 3).

In the illustrated structure, the end wall 20 is provided with a port 31, which in function, can be an outlet port, a valve port 33 and a flow passage designated generally 35 that connects the interior chamber in flow communication with the valve port 33 and outlet port 31. The passage 35 includes a branch 36 that connects the valve port 33 directly with the interior chamber 11 while a branch 39 connects the valve port 33 in flow communication directly with the outlet port 31. As shown, the ports 5, 7, 24, 26, 31 and 33 are threaded to accepted various couplers or devices as hereinafter described. The cylinder 3 is preferably made of an aluminum alloy or other light weight metal alloy but any appropriate material capable of containing the various ports and passages therein may be used, including composite materials.

While it is described that the port 5 is an inlet port and that port 31 is an outlet port, in function, either one of the ports may be an inlet and the other of the ports be an outlet.

In the embodiment of the invention shown in FIG. 2, the valve ports 7 and 33 are positioned on the side of the cylinder 3 with the longitudinal axes of the valve ports being generally perpendicular to the longitudinal axis of the cylinder 3 and the longitudinal axes of the inlet and outlet ports 5, 31, respectively, are generally perpendicular to the longitudinal axis of the cylinder 3. Also, the passage branches 23 and 25 communicate directly with the chamber 11 to provide protection and pressure indication when the valve assembly 13 for the inlet is closed. The embodiment of the invention shown in FIG. 3 has the valve ports 7, 33 with their longitudinal axes generally parallel to the longitudinal axis of the cylinder 3 and the ports 5, 31 with their longitudinal axes generally perpendicular to the longitudinal axis of the cylinder 3 and opening on the side of the cylinder 3. The various ports are formed in the end walls 20, 21 wherein the transverse dimension and the longitudinal axis dimension of the end walls are sufficient to form the various ports therein without attaching couplers or other members thereto to attach the attachments. The valve ports 7, 33 are similar in construction and have partially threaded side walls 37 and a bottom wall 38. A portion of the side wall 37 is threaded and preferably is generally cylindrical with a respective branch 29, 39 opening thereon. The branches 28, 36 open onto the respective bottom wall 38. The diameters and depths of the various ports are such as to facilitate the formation of the branches 28, 29, 23, 25, 36, 39. This can be done after formation of the cylinder 3 by drilling, as an example. The ports 5, 7, 24, 26, 31, 33 may also be made by machining techniques such as drilling and tapping to form pipe or straight threads as desired.

A valve seat 40 is provided in each of the valve ports 7, 33 and preferably is a separate part resting on the bottom wall 38 within the cylindrical portion of the respective valve port. The valve seat 40 may be made of a polymeric material such as PTFE and preferably has a tapered seat surface 42 with a flow opening 43 in line with the respective passage branch 28, 36 to permit flow of fluid between the inlet 5, 31 and chamber 11 through the respective valve port 7, 33 (FIG. 4). In addition to the valve seat 40, the valve assemblies 13 also include a valve body generally designated 45 threaded into the respective port, 7, 33 and sealed to the cylinder by a seal element 46 such as an O-ring contained within a groove 47 and engaging a sealing surface 48 at the respective port 7, 33. The valve body 45 has a threaded section 49 for threaded engagement with the threaded portion of wall 37 of the respective port 7, 33 and is attached directly to the cylinder wherein the cylinder functions as a valve housing for the valve assembly and valve body. The threaded section 49 of the valve body 45 has a free end 50. A wave disc spring 51 is positioned between the free end 50 and a respective valve seat 40 to hold the valve seat in engagement with a wall 38 by controlling the spacing between the wall 38 and end 50. The amount of force applied to the valve seat 40 can be controlled allowing the valve seat to be retained in place in a resilient manner. The valve body 45 includes a hex head 53 to facilitate installation and tightening of the valve body 45 into the respective cylinder end wall 20, 21. The valve body 45 is provided with a generally cylindrical internal threaded portion for removably and moveably mounting a valve stem 55 within the valve body 45. The valve stem 55 includes a threaded shank 56 having a free end 57 on which a handle 58 can be mounted. Preferably the handle 58 is removably mounted on the shank 56. The valve stem 55 has a generally cylindrical seal carrying portion 60 having mounted therein one or more seal members 61 such as O-rings, each in a respective groove 62. The seal portion 60 is received in a cylindrical portion 64 of the body 45 with the seal members 61 forming a seal between the valve stem 55 and the body 45. The valve stem 55 has a valve element closure portion 59 sized and shaped to cooperate with the valve seat 40 and seal surface 42 to effect sealing engagement therebetween. When sealed, flow through the passage 9 is prevented in or out, likewise for the passage 35. While the valve seats 40 are each shown as a separate part, it is to be understood that either or both the valve seat may be formed directly in the material of the end walls 20, 21, if desired, thus eliminating the need for the springs 51.

As described above, the apparatus 1 may be provided with auxiliary devices such as the pressure relief device 17 and the pressure measuring device 15. As best seen in FIGS. 4, 5, the pressure relief device 17 is associated with an end wall 20 or 21 and as shown, the end wall 21. Any suitable pressure relief device 17 may be utilized. For example, a spring loaded pressure relief valve may be attached in the port 24 to provide a multiple use device. As shown, the pressure relief device 17 includes a single use device having a rupture disc 69 mounted in the port 24. Upon reaching a pre-determined pressure, the disc 69 will break allowing fluid to escape through an exhaust port 70. By controlling the size of the exhaust port 70, the rate of discharge of fluid can be controlled. The disk 69 is sealed to the bottom wall 71 of the port 24 via a suitable seal, 73 engaging with a portion of the disc 69 and the bottom wall 71. The disc 69 is held in place and in sealing engagement with the seal 73 by a cap 74 having a threaded side wall 77 removably mounted in the port 24 by threaded engagement with a port side wall 75. The cap 74 may be provided with a hex head or the like to facilitate installation and tightening of the cap 74 by a wrench or the like. As shown, the exhaust 70 is through the side wall 77 of the cap 74.

In the illustrated structure, and as seen in FIGS. 4, 5, the pressure measuring device 15 is shown as a bourdon tube type pressure gauge 79 having a needle or other indicator overlying a scale 81 to indicate the gauge pressure of the fluid in the chamber 11. The gauge 79 is removably mounted in the port 26 by threaded engagement between a coupler 83 and threaded side wall 84 of the port 26. A seal may be effected between the coupler 83 and a side wall 84 as for example by providing a pipe thread connection with sealing material between the coupler 83 and the side wall 84. Alternatively, other pressure measuring devices may be provided other than a mechanical type gauge, if desired.

In the structure illustrated and described above, the apparatus 1 is provided with two valve assemblies and two inlet port and passageway structures, one in each end of the cylinder. It is to be understood that the assembly may be utilized with only one valve and one set of ports wherein the valve can be constructed to provide closure for both an inlet and outlet simultaneously thereby eliminating the need for a second valve assembly and port arrangement.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly attended that the claims set forth below shall cover all such changes, modifications, variations and other uses and applications that do not depart from the spirit and scope of the present invention as described herein.

Other aspects, objects and advantages of the present invention can be obtained from a study of the drawings, the disclosure and the appended claims.

1. A sampling cylinder apparatus for collecting a sample of a hydrocarbon fluid, said apparatus comprises:
a fixed volume cylinder comprising a side wall and a pair of end walls, said side wall and end walls defining an interior storage chamber;
a first port formed in at least one said end wall;
a valve port formed in at least one said end wall;
at least one passageway formed in at least one said end wall forming a flow passage in flow communication between the interior storage chamber, the valve port and the first port; and
a valve assembly associated with the end wall containing the valve port, said valve assembly including a valve element removably mounted within the valve port and being operable to selectively permit flow and prevent flow of fluid into and out of the storage chamber through the first port, said end wall forming a housing for the valve assembly.

2. An apparatus as set forth in claim 1 wherein there is a said first port and a said valve port formed in each said end wall and a said valve assembly associated with each said valve port one said first port is a filling port and the other first port is an exhaust port, a respective end wall forms a housing for a respective said valve assembly.

3. An apparatus as set forth in claim 2 wherein at least one of the valve assemblies includes a valve seat positioned in a respective valve port and selectively engageable with a closure portion of the valve element for selectively opening and closing a respective said flow passage by movement of the closure portion out of and into engagement respectively with a respective said valve seat.

4. An apparatus as set forth in claim 3 wherein at least two of the valve assemblies each includes a valve seat positioned in a respective valve port and selectively engageable with the closure portion of the respective valve element for selectively opening and closing a respective said flow passage by movement of the closure portion out of and into engagement respectively with a respective said valve seat.

5. An apparatus as set forth in claim 4 wherein the valve seats are separate from the cylinder and are each removably mounted in a respective said valve port.

6. An apparatus as set forth in claim 5 wherein the valve assemblies each include a body with a respective valve element moveably mounted therein and include at least one O-ring sealing each of the valve elements to a respective said valve body.

7. An apparatus as set forth in claim 1 wherein the cylinder is of metal formed as a one piece unit.

8. An apparatus as set forth in claim 7 wherein the side wall is seamless.

9. An apparatus as set forth in claim 7 wherein the cylinder is made by spin forming.

10. An apparatus as set forth in claim 9 wherein the cylinder is of a metal alloy including aluminum.
